(19) United States
(12) Patent Application Publication
(10) Pub. No.: US 2004/0245047 A1
(43) Pub. Date: Dec. 9, 2004

(54) Device for rescuing persons from edifices such as buildings, drilling platforms, ships or the like

(76) Inventor: Herwig Fischer, Poznan (PL)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/493,644

(22) PCT Filed: Oct. 24, 2002
(86) PCT No.: PCT/DE02/04002

(30) Foreign Application Priority Data
Oct. 25, 2001 (DE) 101 52 833.7

(51) Int. Cl. A62B 1/06

(52) U.S. Cl. 182/70

(57) ABSTRACT

The invention relates to a device for rapid evacuation of people from edifices on fire or in other dangerous situations. The inventive device consists of an abseiling device which slides downward by the force of gravity on a downward hanging rope upon engagement. A braking device ensures that the speed at which the abseiling device slides downward does not exceed a given maximum value. The rope is secured or can be secured on a pivotally articulated extension arm which is firmly connected to the edifice. The abseiling device can be engaged and disengaged by means of a rapid clamping device.

High buildings which are occupied by many persons, like hotels, office skyscrapers or even skyscrapers for housing [apartment houses] are always under the risk that evacuation in the case of danger, for example from fire, terrorist attack, earthquake, etc. will not be rapid and safe enough. The elevators cannot be used or can be used only with risk that there may be a power failure. A descent through the stairwell of the building not only can take an excessive length of time but is also highly stressful, especially for lame individuals, children or older people. Frequently the stairwells are also blocked by smoke.

In skyscrapers in which a large number of people are to be found, an evacuation through the stairwell in the shortest period of time is hardly possible. The speed with which a building can be evacuated is a function to various extents of the number of individuals who are to be found in the building as well as the speed with which the slowest individuals can move. A rescue via an extendable ladder as are employed by firefighters or technical service personnel is a conceivable answer but depending upon the number of people to be rescued is also an expensive and slow approach. In addition, many people suffer from such a high level an angst or a sense of dizziness that rescue is particularly difficult and even prevented.

An alternative is a rescue by abseiling [descent by rope]. For this purpose a rope [cable] can be affixed on an outer wall of the building. A suspension of individuals from a cable, especially from great heights, is however only practical as a sports action. If a cable or rope which is affixed on an outer wall of the building to be used for abseiling as an escape measure, it must be reachable by a multiplicity of people from different levels [stories or floor levels] so that there is the danger that many people will simultaneously engage the rope or cable which may not be able to carry the collective weight. Furthermore, the rope or cable which can be sensitive to fire can be damaged by flames emerging from window openings. To overcome such drawbacks, an abseiling device is proposed in German patent document DE 202 03 970 U1 which has a cable or rope supply from which the cable or rope can be drawn off and which at its end has a fastening device for suspending the cable in a stationary support. The cable is wound up on a drum which is rotatably arranged in a shell fastened on a standing platform with a central column and hand grips arranged thereon. One of the grips is configured as a rotary grip for actuating a brake. This device has however the drawback that only one single person can abseil downwardly with it.

Similar abseiling devices are for example described in DE 35 46 429, DE 39 22 825 C2, DE 39 24 218 A1 or DE 38 26 401 A1.

It is the object of the present invention to provide a device which can be installed in a structure which will work in a reliable manner and enable with out danger the rescue of persons requiring assistance from the aforementioned structures.

This object is achieved with the device according to claim 1. A substantial part of the device has a pivotal outrigger connected at a fixed location with the structure and on which the cable or rope is fastened or is fastenable. Because of the length of the outrigger, in the abseiling of the persons requiring assistance, a sufficient distance from the structure is maintained which limits the ability of wind or other affects to cause injury to the abseiling individual against the structure wall.

The abseiling device has a support surface which preferably is conformed as a sitting surface on which the person to be lowered can be belted by safety belts or other harnesses. In addition, the abseiling device by means of a rapid clamping device [quick connector] which can be latched in or out, enables the abseiling device to be connected with the cable or rope for the abseiling process. In order to ensure that the people to be rescued will only abseil with a suitable speed, the abseiling device has a brake device which preferably has a control compensating for different body weights upon the sliding speed and produces a weight proportional braking force so that a maximum speed is not exceeded. The advantage of the apparatus according to the invention resides in a simple construction and its facile maintenance. The outriggers can be provided at each floor or level of the structure or at every second floor or level and so arranged that the external weather does not affect it. Expensive maintenance or mechanical or electrical controls are not required. In practice, endangered individuals instinctively flee in the direction of the outer facade of the building to the windows and not to the center of the building with the stairwells and elevator shafts. To rescue people found at this floor, the outrigger must be swung outwardly and the fire-resistant cable or rope provided at this end and preferably composed of steel unrolled. The cable lengths are determined by the floor on which the device is provided. Depending upon the occupancy to be expected on the floor, a sufficient number of abseiling devices are provided for the personnel to be rescued. Before abseiling, the outrigger is swung again inwardly so that the cable at the respective stage can be reached and whereupon, for example, through the aid of an assistant, the quick connect of the cable on the abseiling device joined to the cable. When this is done, the outrigger can again be swung outwardly so that the abseiling device lowers with fully automatic speed control. Preferably and as reviewed again later, auxiliary means is provided whereby the abseiling sliding speed before reaching the ground is strongly minimized or damped so that impact injuries are avoided. When the abseiling person reaches the ground, the quick-connect device is unlatched so that the next person after a corresponding inward swing of the outrigger can slide down the cable or rope on his or her abseiling device. Apart from the latching in or out of the abseiling device to the cable, no action is required by the person to be rescued.

Preferably the support surface of the abseiling device is formed with a seating surface with a backrest on the outer wall of which the device for lateral guidance and the quick-connect unit are affixed. Only with these features can it be ensured that the abseiling person will be able to operate the quick-connect device.

In accordance with a further refinement of the invention the abseiling device has a cable guide with a multiplicity of rerouting rollers or slide guides with looping means which preferably generate a weight proportional friction force. The cable or rope guide especially can have rollers or slide elements which can be pressed against the cable or robe as it slides by the abseiling device for braking. As an alternative thereto, the cable or rope guide can have hydraulically effective brake rotors which are arranged in a viscous mass of a liquid and/or a solid/liquid mixture. The brake device serves to limit the sliding speed during abseiling without requiring the rescued person to intervene himself.

In accordance with another refinement of the invention, at the cable end an inflatable or liquid-filled rescue island is affixed which damps the impact. By the construction of the seating shell, which enables the rescued person to be seated with slightly spread legs, together with the provision of the “soft” rescue island, it can be ensured that leg injuries can be avoided to the greatest extent possible. Preferably the rescue island together with the rolled up cable or rope is affixed as a packet on the outrigger and which is released upon the initial swinging out of the outrigger and the unrolling of the cable or rope. If the cable or rope is unrolled, a lever or the like can open the closure of a propellant gas flask via a tension spring and which is located in the interior of the rescue island so that the emerging propellant gas serves for the automatic inflation of the rescue island.

Alternatively it will be self-understood within the framework of the present invention to be possible to inflate the rescue island by means of hydraulic or pneumatic devices provided on the ground. According to a further feature of the invention, the rope or cable is clampable between the outrigger and a hook anchored in the ground alongside the building. This has the advantage that the cable is not tensioned only by the weight of the rescue island.

According to a further feature of the invention, the structure is provided at respective levels with a platform or stepping surface which can be swung outwardly or inwardly and which after being swung outwardly can serve as a standing surface for the individuals to be rescued as well as an aide who can latch the individuals abseiling device to the cable or rope and thereafter swing the outrigger horizontally, following which the abseiling automatically begins. This stepping surface has the advantage that the person to be rescued still has a fixed position upon latching of the abseiling device. So as to avoid further angst, it can additionally be provided that two vertical optical barrier walls connected together by a hinge and can form a practically visual closed space in all directions but upwardly can be provided on the platform. Each person to be abseiled along the cable steps from the building onto the support surface from one side and into what appears to be a downwardly closed chamber which only opens after the swinging out of the outrigger, that is at a time point at which the person to be rescued is already connected by the abseiling device with the rope or cable. In accordance with a further feature at the lower cable end, a spring damping device is arranged which brakes the sliding speed of the abseiling device.

In order to keep the quick-connect unit simple, this is comprised preferably of a roller system which is actuatable by means of a pivot lever. When the roller system is connected with the cable or rope, a safety lever is additionally actuated to prevent the cable or rope from springing from the roller guide.

Preferably in the region of the cable end, that is in the region of the ground or the region of the rescue island, cable branches or thickened portions of the cable or rope, like cams or the like, can be provided which results in an automatic opening of the quick-connect unit so that rescued individuals can leave the rescue island in the most rapid manner, or be taken into safety as rapidly as possible.

The abseiling unit itself can also have additional braking rollers which are connected by a transmission with the remaining rerouting rollers and which rotate in senses opposite to the rerouting rollers on the cable or rope and thus provide a corresponding pressing engagement on the cable or rope with a braking effect.

In an ideal case, the outrigger and the platform form a unit which can be folded together or apart and which can be arranged at each floor but preferably at least every other floor in the interior of the structure and can be actuatable mechanically, hydraulically and/or electrically. As has already been indicated, the cable or rope can be wound in a spiral configuration in a cable or wire drum and preferably is connected at one end fixedly with the outrigger. In the case of an emergency, a corresponding emergency switch can cause the entire system to be opened outwardly, whereby with the swinging out of the outrigger, the platform, the vertical optical barrier walls and the cable or rope drum or the cable or rope coiled into a roll is freed so that after the complete unrolling of the cable or rope and the inflation of the rescue island, the outrigger can be swung back in, so that an aide can grip the cable end and latch the first person with his or her abseiling device thereon.

Further advantages and various embodiments of the invention are illustrated in the drawing. They show

FIG. 1 a schematic elevation of a skyscraper with a rescue device according to the invention,

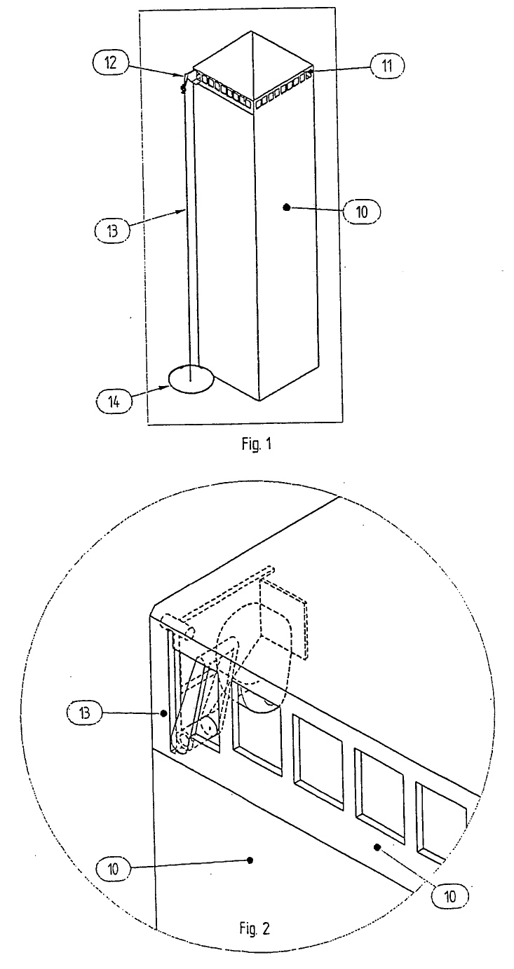

FIGS. 2 to 6 respective partial elevations of the upper building floor at various points in time with schematic functional illustration of the rescue device and

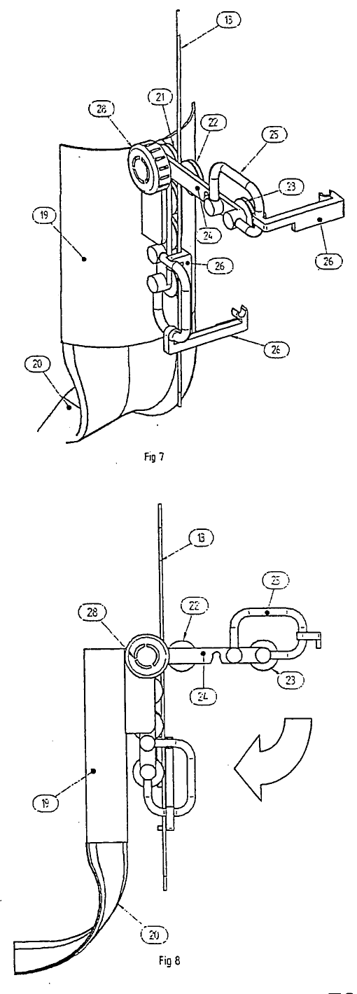

FIGS. 7 and 8 respective elevations of the abseiling unit.

In FIG. 1, a skyscraper 10 has been shown having an upper floor 11 in which the apparatus of the invention is disposed. The same can apply to other floors, preferably each floor of the building 10, whereby the individual apparatuses are each offset from one another at several horizontal spacings. FIG. 1 shows the apparatus 12 in its outwardly folded state with the outwardly unfolded outrigger at whose end a cable or rope 2 is fastened and to which a rescue island 14 is connected. The rescue island 14 is connected with the cable or rope and holds the cable or rope taut by its weight; the rescue island, because of its correspondingly large diameter, holds the rescue cable or rope at a distance from the building wall.

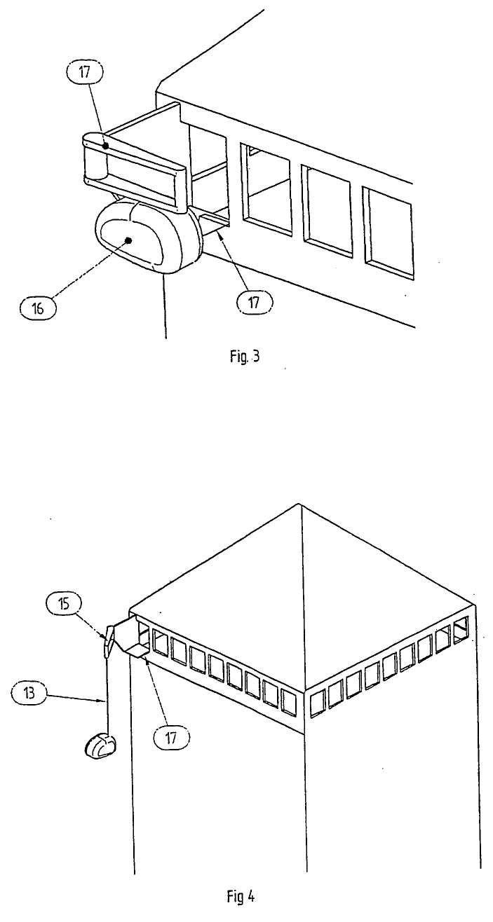

FIG. 2 shows the apparatus 12 according to the invention in its folded together state within the building and in which the entire device is disposed within the upper floor 11 of the building 10. In the case of an emergency, the outrigger 15, on whose tip a cable or rope drum 16 is affixed can be swung outwardly in accordance with FIG. 3. Simultaneously a platform 17 is swung downwardly and later can serve as a standing surface.

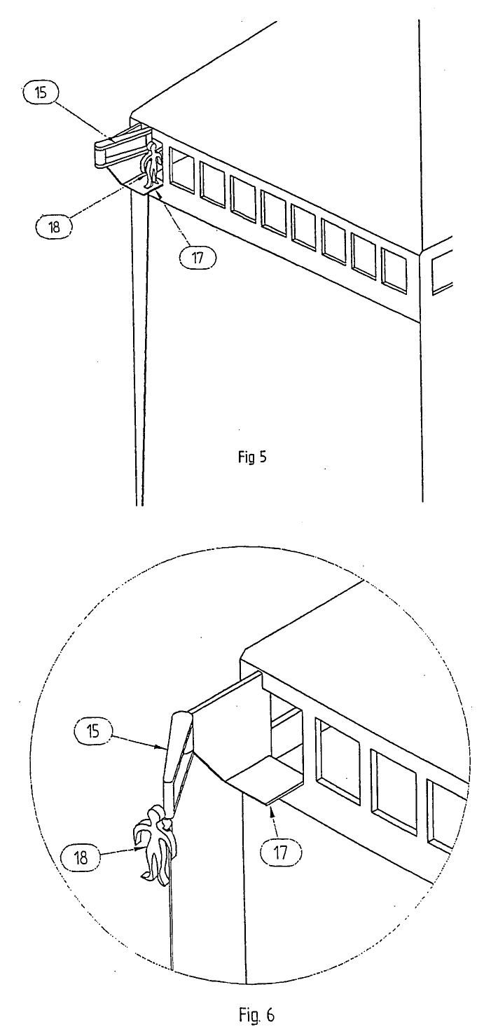

As is visible from FIG. 4, after the outrigger has been swung outwardly, the cable 13 is unrolled. As soon as this unrolling is complete, the rescue island is inflated. For the rescue of the first person, the outrigger 15 is swung inwardly again so that the person 18 who is standing on the platform 17, can have his abseiling device latched to the cable. After the corresponding attachment of the abseiling device, which has not been illustrated in FIGS. 5 and 6, the outrigger 15 is again swung outwardly so that the person 18 can slide downwardly for rescue. A basic illustration of the abseiling unit is visible from FIGS. 7 and 8 in which a seating shell with a backrest 19 and a seating surface 20 are shown and which are so shaped that the person 18 to be rescued can be seated firmly with slightly spread legs. Safety belts and retaining loops which engage the person 18 to be rescued and which fix that person to the seat 19, 20, have not been shown. On the rear wall of the backrest, the device for guiding the cable or rope and the quick-connect device are fastened. These units comprise three rollers 21, 22 and 23 which are fastened on a rail 24. Initially, when the outrigger 15 is swung inwardly, the cable or rope 13 is positioned between the rollers 21 and 22, whereupon this rail is swung in the direction of the arrow 26 through 90° with the aid of the grip 25 so that the cable or rope is guided through the roller system 21, 22 and 23. Then the pivotal safety lever 26 is swung upwardly in the direction of arrow 27 so that the lever assumes the position 26 as shown in FIG. 7. Subsequently the abseiling downwardly can be started by swinging out the outrigger 15. At least one of the rollers is connected with a brake device 28 which, for example, is hydraulically effective.

Not shown are vertical optical barrier walls with which the outriggers 15 are connected and which in an inwardly swung state of the outrigger according to FIG. 5, block the site all around the abseiling device.

With the swinging out of the outrigger, the abseiling of the person 18 to be rescued begins and first at this point in time can be the person recognize the height from which he or she is about to be rescued. Panic-like reactions or refusals to allow connection to the cable are thus greatly minimized. Because of the feature that the abseiling unit is affixed by the quick-connect device on the backside of the backrest 19 also avoids efforts to grab the quick-connect device in a panic reaction and open the latter. The embodiment shown in FIGS. 7 and 8 of the abseiling device must be serviced by an aide who is left behind as the last person. To allow even this individual to abseil down the cable or rope, in a variant of the abseiling device, a quick-connect unit can be provided which is fastened either laterally or in the front so that this person can latch it to the cable by himself or herself. Optionally the seating surface 20 can be rotated by 180° from the illustrated seating surface and can be slit optionally in the middle so that the cable or rope 13 can pass through it. Instead of a closed seating surface 20, then two separate leg shells can be provided.

The speed of descent of the abseiling device is limited according to the invention, for example, in that the guide device 21-24 is pressed against the cable or rope 13 by a lever system or some other clamping device automatically with a force which is proportional to the weight of the person 18 to be rescued. The friction pairing between the cable or rope and the guide can then be so selected that the wear does not occur in the cable or occurs in the cable to a very limited extent and may to the greatest part occur in the guide 21-23 since the latter is used only once while the cable must remain intact for additional people. As a result, cable or rope material is preferably selected as a steel which will not tear like textiles or plastic ropes or become damaged by flames. To limit the descent speed of the abseiling device, this can also have a centrifugal brake.

In a special configuration, a wear ratio is selected that gives rise to a speed proportional friction force so that independently of the height of the fall, a stationary descent state is reached during the abseiling in which a certain limiting speed is not exceeded.

In an embodiment of the invention, travel is over rollers and the roller speeds can be braked by a liquid brake 28 to a maximum speed and thus a maximum descent velocity. In addition the rescue cable or rope 13 can be passed in a loop through the guide.

Alternatively, especially in the case of limited building heights, a braking effect can reduce the descent velocity at a certain height before impact upon the rescue island in that the rescue cable or rope in a lower region is thickened so that the friction force will be increased. The rescue cable or rope 13 can also be provided with a special friction coating in this braking zone. Additionally, spring damping devices are possible at the lower cable end so that upon travel of the abseiling device into this region the descent velocity will be reduced to a minimum value.

The guide device can optionally also be filled with a visco-elastic liquid which during the downward movement emerges between the guide and the cable or rope so that an approximate speed proportional friction force is generated which is effective in a manner similar to that of oil-lubricated slide bearings. Optionally the fall during abseiling can have its speed limited also by an air brake screen [umbrella]. This brake screen can be fastened on a guide. By contrast with a parachute rescue in which the person to be rescued alternatively jumps and the release of the parachute must be triggered, the connection to the cable remains however so that a drifting of the falling person in the direction of the building wall by the effect of wind can be avoided.

In another variation, the braking device can also be a so-called Stotter brake in which the roller and slide system is set into a resonance vibration and whereby at certain time-spaced or positional spacing a periodic braking is effected. With the guide embodiment illustrated in FIGS. 7 and 8, it can also be ensured that the person to be rescued will not come into contact in an undesirable manner with the cable or rope.

As has already been indicated, an automatic unlatching device can also be provided which through cams, thickenings or the like on the rope or cable 13, effects a disengagement of the abseiling device so that after reaching the ground or the rescue island, the person can move away from the region of the end of the cable as quickly as possible so as not to collide with individuals falling down the latter.

So that people with angst, older people, individuals who have no sporting sense or who are lame or children can be rescued, retaining scoops for two or more people can be provided or one seating surface 19, 20 can be so shaped that in addition to he first person, another person can abseil down the cable or rope as in the case of a parachute.

Advantageously the rescue system of the invention should be of a modular construction so that it can be retrofitted to already existing structures upon window frame replacement as a complete unit. Since the outrigger as well as the cable roll lie in the interior and are only swung outwardly in the case of need, the system is protected against weather-based corrosion and is largely maintenance-free. On every floor, the position of the outrigger or rescue cable or rope is offset from those of the neighboring floor so that rescue action from different floors will not hinder each other. The platform 17 has in this case the further advantage that the spacing of the people to be rescued from the building wall is increased already at the beginning with respect to initiation of an abseiling process.

With the aforedescribed features it can be ensured that the abseiling speed or descent speed will be limited to avoid the risk of increased risk of injury at the cable or rope end resulting from a high impact speed. The rescue cable or rope is so rolled up that in case of an emergency it can unroll by itself. As the braking device for the abseiling unit, mechanically-operating systems are preferred, that is cable guides with braking effectiveness, loops, slide elements, intermittently-operating stotter brakes, liquid damping, gas damping or viscous damping media as well as thickened or branching cables or ropes toward the bottom.

The rescue islands should be so configured that they automatically inflate upon impact and are thus self-activating. As a result costly time which otherwise would be required for the intervention of assisting personal (firefighters, etc.) can be eliminated. For tandem abseiling devices, other cable or rope guide systems are optionally used which provide stronger braking characteristics.

In the framework of the present invention it is also possible to so configure the cable guiding on the outrigger that the individuals to be rescued can slide downwardly initially over a horizontal or slightly inclined cable before they reach the vertical cable.

The cable can also be provided with pulse generators which enable a control as to whether the cable has completely unrolled.

The present invention is basically suitable for all kinds of buildings like tall apartment houses [skyscrapers] but also drilling rigs or ships although in the latter case, for the abseiling into water, damping means at the cable end are unnecessary.

After the evacuation of a floor, especially when the cable end is anchored in the ground, the tension cable can serve to enable the rescue forces via motor-driven lift devices to utilize the cable to permit fire-extinguishing activity or the like at the upper floors.

1. An apparatus for the rescue of people from structures like buildings (10) drilling rigs, ships or the like having an abseiling device provided with a support surface which slides downwardly on a downwardly-hanging cable or rope (13) upon latching of the abseiling device thereto by gravity, whereby the sliding safety of the abseiling device is minimizable by a provided brake device, characterized in that the cable or rope (13) is fastened or fastenable on an outrigger (15) swingably connected with the structure (10) at a fixed location and in that the abseiling device by means of a quick-connect device can be latched onto and unlatched from the cable or rope, whereby the sliding speed of the abseiling device preferably does not exceed a maximum speed.

2. The apparatus according to claim 1 characterized in that the support surface of the abseiling device is a seating device (20) which preferably is connected with a backrest (19) on whose outer wall the devices for guiding the cable or rope and the quick-connect device are affixed.

3. The apparatus according to claim 2 characterized in that the abseiling device has a cable guide with a plurality of rerouting rolls (21, 22, 23) or slide guides with looping means, which preferably provide a speed proportional breaking force and/or the abseiling device has a centrifugal brake.

4. The apparatus according to claim 2 characterized in that the cable guide has roller or slide elements which upon the sliding down of the abseiling device, roller or slide elements which press against the cable or rope for braking and/or the cable or rope guide has hydraulically effective brake rotors which are arranged in a viscous mass of a liquid and/or of a solid-liquid mixture.

5. The apparatus according to claims 1 characterized in that at the cable or rope end an inflatable or liquid-filled rescue island (14) is fastened.

6. The apparatus according to claims 1 characterized in that the cable or rope (13) is tensionable between the outrigger (15) and a hook anchored next to the structure (10) in the ground.

7. The apparatus according to claims 1 characterized in that a platform (17) is connected with the structure (10) so that it can be swung outwardly and after being swung upwardly can serve as a standing surface for the person to be rescued together with an aide who latches the abseiling device onto the cable or rope (13) and then swings the outrigger (15) horizontally outwardly.

8. The apparatus according to claim 7 characterized in that at least two vertical optical barrier walls are connected by a hinge with one another and to the outrigger so that the optical barrier wall form a tightly-closed space open only upwardly together with the platform (17).

9. The apparatus according to of claims 1 characterized in that at the lower cable end a spring damping unit is arranged which brakes the sliding speed of the abseiling device.

10. The apparatus according to claims 1 characterized in that the quick-connect device is comprised of a roller system which is actuatable by means of a pivot lever (24) and a safety lever (26) and engages the cable or rope.

11. The apparatus according to claims 1 characterized in that, in the region of the cable end, cable branches or cable thickenings such as cams are provided which cause an automatic opening of the quick-connect device.

12. The apparatus according to claims 1 characterized in that the abseiling device has truck rollers which are connected by a transmission with the remaining rerouting rollers and rot-ate counter to the rerouting rollers and by pressing against the cable apply a brake effect.

13. The apparatus according to claims 7 characterized in that the outrigger (15) and the platform (17) form a unit which can be folded together and which is located in the interior of a floor of the structure and is mechanically, hydraulically and/or electrically actuatable.

14. The apparatus according to claims 1 characterized in that the cable or rope (13) is wound in a spiral shape on a cable drum (16) or over a core or is rolled up freely and preferably at an end is fixedly connected with the outrigger (15).
